(19) United States
(12) Patent Application Publication
(10) Pub. No.: US 2005/0223289 A1
(43) Pub. Date: Oct. 6, 2005

(54) SEMICONDUCTOR EMBEDDED MEMORY DEVICES HAVING BIST CIRCUIT SITUATED UNDER THE BONDING PADS

(76) Inventor: Ming-Jing HO, Hsin-Chu City (TW)

Correspondence Address: NORTH AMERICA INTERNATIONAL PATENT OFFICE (NAIPC), P.O. BOX 506, MERRIFIELD, VA, 22116, US

(21) Appl. No.: 10/708,762

(22) Filed: Mar. 24, 2004

(51) Int. Cl. G06F 11/00

(52) U.S. Cl. 714/30

(57) ABSTRACT

An embedded memory chip having BIST (built-in self test) circuit under pad is disclosed. The embedded memory chip includes a logic circuit and a memory unit coupled to the logic circuit. The logic circuit and memory unit are fabricated substantially in a center area of the embedded memory chip. A number of bonding pads are situated on a peripheral area adjacent to the center area of the embedded memory chip. The BIST circuit is situated directly under at least one of the bonding pads. The BIST circuit is activated when implementing an IC testing on the embedded memory chip for detecting faults in the memory unit and is deactivated as a disuse part of the embedded memory chip after finishing the IC testing.

### BACKGROUND OF INVENTION

1. Field of the Invention

The present invention relates generally to semiconductor memory devices having self-testing capability, and more particularly, to semiconductor embedded memory devices having BIST (Built-In Self Test) circuit situated under the bonding pads, thereby allowing the formation of memory devices with smaller die areas without the fear of reliability issue.

2. Description of the Prior Art

Semiconductor chips (dice) are manufactured by fabricating a plurality of identical integrated circuits on a wafer, scribing the wafer between the integrated circuits, and subsequently breaking apart the wafer into individual chips. Before dicing the wafer, the semiconductor chips in a wafer state are typically subjected to an operational test by using an external testing device (IC tester). As the recent semiconductor memory devices have faster operation speeds and larger capacities, a BIST (Built-In Self-Test) circuit formed in advance in each chip is used in an operational test in order to assist such an external testing device. As known in the art, the BIST technology is a powerful tool for testing embedded memories. It saves a great deal of testing time and increases the IC tester capacity.

After testing, the chips are then mounted on lead frames or substrates for packaging and wire bonded for chip external connections. Thermocompression and ultrasonic bonding techniques are commonly used in the art. In thermocompression bonding, heat and pressure are applied to the pad and to the underlying substrate in order to achieve the bond. In ultrasonic bonding, sufficient energy is supplied by ultrasonic vibration in order to achieve the bond. The bonding wire connects the bonding pads, which are metal areas located on the periphery of the integrated circuit, with the lead frame. The area underneath the bonding pads occupies a substantial fraction of the entire chip surface.

The conventional bonding process used to form the connection typically requires either or both elevated temperatures, high pressures and ultrasonic energy to produce a good connection between the bonding wire and the pad. The strict bonding conditions produce thermal or mechanical stresses in the dielectric underlying the pads. The stress may cause defects that result in leakage currents through the dielectric between the bonding pads and the underlying substrate, which is frequently electrically conducting. Consequently, the reliability issues preclude use of the substrate area under the bonding pads for device purposes thereby decreasing the efficiency of substrate utilization for device purposes.

Attempts have been made to place active area of a chip underneath the bonding pads, thereby reducing valuable die area and thus product cost. The circuits situated under the bonding pads are mostly electrostatic discharge (ESD) protection circuits, which, in operation, are frequently in a conductive state.

For example, Lee in U.S. Pat. No. 5,652,689 filed Aug. 29, 1994, which is owned by the same assignee of the present application, discloses a circuit for protecting a bonding pad of a semiconductor device from ESD voltages. The circuit is located under the pad to permit the space otherwise used for a protection circuit to be used for normal operating components. Huang et al. in U.S. Pat. No. 6,157,065 filed Jan. 14, 1999 discloses an electrostatic discharge protective circuit under an input pad.

The prior art integrated circuits having pads over an ESD circuit are subject to long-term reliability problems. In some cases, reinforcement means for the area underneath the pads are added in order to avoid thermal or mechanical stresses during wire bonding and to prevent potential damages to the ESD circuits. This means additional cost and more complicated design.

### SUMMARY OF INVENTION

In light of the above, it is therefore an object of the present invention to provide an embedded semiconductor memory device having self-testing capability. The semiconductor memory device has a BIST (Built-In Self-Test) circuit situated under the bonding pads, thereby allowing the formation of memory devices with smaller die areas without the fear of reliability issue.

According to the claimed invention, an embedded memory chip having BIST (built-in self test) circuit under pad is disclosed. The embedded memory chip includes a logic circuit and a memory unit coupled to the logic circuit. The logic circuit and memory unit are fabricated substantially in a center area of the embedded memory chip. A number of bonding pads are situated on a peripheral area adjacent to the center area of the embedded memory chip. The BIST circuit is situated directly under at least one of the bonding pads. The BIST circuit is activated when implementing an IC testing on the embedded memory chip for detecting faults in the memory unit and is deactivated as a disuse part of the embedded memory chip after finishing the IC testing.

Other objects, advantages, and novel features of the claimed invention will become more clearly and readily apparent from the following detailed description when taken in conjunction with the accompanying drawings.

### BRIEF DESCRIPTION OF DRAWINGS

FIG. 1 is a block diagram that schematically illustrates an embedded memory device in accordance with a preferred embodiment of the present invention.

### DETAILED DESCRIPTION

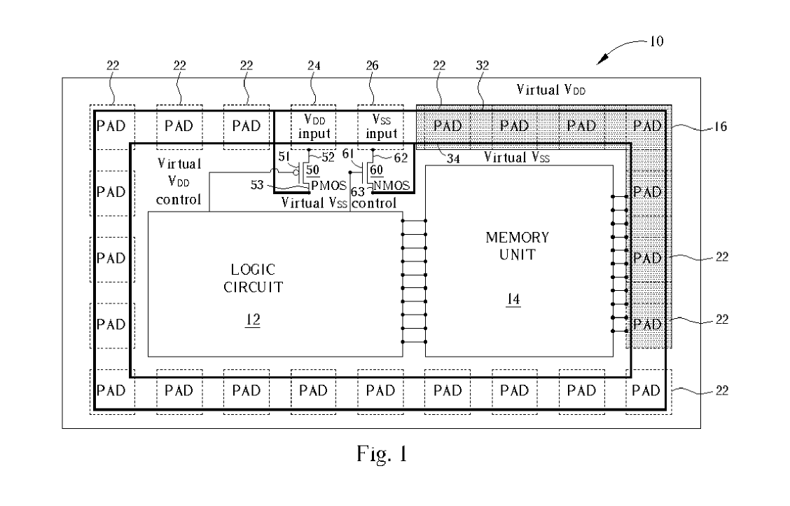

Please refer to FIG. 1. FIG. 1 is a block diagram that schematically illustrates an embedded memory device 10 with self-testing capability, in accordance with one preferred embodiment of the present invention. The embedded memory device 10 is an integrated circuit chip comprising a logic circuit 12 and a memory unit 14 embedded in the integrated circuit chip. The embedded memory device 10 may be a semiconductor processing chip, such as a network interface adapter, but not limited thereto. The memory unit 14 may be used for on-chip storage and recall of data by other elements on the chip. The memory unit 14 includes a memory array (not explicitly shown), which, as known in the art, has data input/output connections and address connections, by means of which the other elements on the chip can write data to and read data from the memory array. Details of the memory unit 14 are omitted since they are not germane to the present invention.

The logic circuit 12 and the memory unit 14 are fabricated substantially in a center area of the embedded memory chip 10. On a peripheral area adjacent to the center area of the embedded memory chip 10, a plurality of bonding pads 22 are provided. As mentioned, the bonding pads 22 are metal areas located on the periphery of the integrated circuit. Bonding wire connects the bonding pad with a lead frame (not shown). The area underneath the bonding pads 22 occupies a substantial fraction of the entire chip surface.

The embedded memory device 10 further comprises a BIST circuit 16 (indicated by shadow area) for detecting faults in the embedded memory chip 10. According to one preferred exemplary embodiment, the BIST circuit 16 comprises a data generator, which outputs a pattern of test data for writing to the cells of memory array in the memory unit 14. The BIST circuit 16 reads the data out of the memory array, and compares these data to the test data output by data generator using a comparator. If the data read out of the memory array match the test data written to the memory array, the comparator generates a “pass” output, indicating that the memory array is working properly. Otherwise, the comparator generators a “fail” output.

The BIST circuit 16 is only activated when the embedded memory device 10 is subjected to a functional self-test based on the instructions from an IC tester. The BIST circuit 16 is “deactivated” after finishing the IC testing process. The BIST circuit 16 is provided only for IC testing purposes, and only works during the IC testing process, which is implemented before wire bonding. In other words, the BIST circuit 16 becomes a disuse part of the embedded memory chip 10 after finishing the functional IC testing. Therefore, there is no need to consider either short-term or long-term reliability issues with respect to the BIST circuit 16. The present invention also features that the BIST circuit 16 is situated directly under the bonding pads 22, thereby allowing the formation of memory devices with smaller die areas.

In FIG. 1, virtual V_{DD} and V_{SS} voltages for the operations of the BIST circuit 16 during a self-test process are provided through two separate power supply lines 32 and 34, respectively. Both of the power supply lines 32 and 34 are situated under the bonding pads 22 and substantially encircle the center area of the chip in which the logic circuit 12 and the memory unit 14 are fabricated. The V_{DD} power supply line 32 is connected to a drain terminal 53 of a MOS transistor 50, preferably a PMOS transistor (acting as a switching device). The PMOS transistor 50 has a control gate 51 electrically connected to a virtual V_{DD} control circuit in the logic circuit 12, and a source terminal 52 coupled to real V_{DD} input 24. The V_{SS} power supply line 34 is connected to a drain terminal 63 of a MOS transistor 60, preferably an NMOS transistor. The NMOS transistor 60 has a control gate 61 electrically connected to a virtual V_{SS} control circuit in the logic circuit 12, and a source terminal 62 coupled to real V_{SS} input 26. Both of the PMOS transistor 50 and NMOS transistor 60 are not situated under the bonding pads. The BIST circuit 16 is “deactivated” after finishing the IC testing process by shutting down the PMOS transistor 50 and NMOS transistor 60.

Those skilled in the art will readily observe that numerous modifications and alterations of the present invention may be made while retaining the teachings of the invention. Accordingly, the above disclosure should be construed as limited only by the metes and bounds of the appended claims.

1. An embedded memory chip, comprising:
a logic circuit;
a memory unit coupled to said logic circuit, wherein said logic circuit and said memory unit are fabricated substantially in a center area of said embedded memory chip;
a plurality of bonding pads situated on a peripheral area adjacent to said center area of said embedded memory chip; and
a built-in self test (BIST) circuit situated under at least one of said bonding pads for detecting faults in said embedded memory chip.

2. The embedded memory chip according to claim 1 wherein a V_{DD} power is provided to said BIST circuit by said logic circuit through a V_{DD} power supply line that is situated under said bonding pads and encircles said center area.

3. The embedded memory chip according to claim 2 wherein said logic circuit is coupled to a first switching device for controlling said V_{DD} power to said BIST circuit.

4. The embedded memory chip according to claim 3 wherein said first switching device is a MOS transistor, and wherein said MOS transistor has a control gate that is electrically connected to said logic circuit, a source terminal that is biased to an external V_{DD} power supply node, and a drain terminal that is electrically connected to said V_{DD} power supply line.

5. The embedded memory chip according to claim 3 wherein said first switching device is a PMOS transistor.

6. The embedded memory chip according to claim 3 wherein said first switching device is not situated under any of said bonding pads.

7. The embedded memory chip according to claim 1 wherein a V_{SS} power is provided to said BIST circuit by said logic circuit through a V_{SS} power supply line that is also situated under said bonding pads and encircles said center area.

8. The embedded memory chip according to claim 7 wherein said logic circuit is coupled to a second switching device for controlling said V_{SS} power to said BIST circuit.

9. The embedded memory chip according to claim 7 wherein said second switching device is an NMOS transistor.

10. The embedded memory chip according to claim 7 wherein said second switching device is not situated under any of said bonding pads.

11. An embedded memory chip, comprising:
a logic circuit;
a memory unit coupled to said logic circuit, wherein said logic circuit and said memory unit are fabricated substantially in a center area of said embedded memory chip;
a plurality of bonding pads situated on a peripheral area adjacent to said center area of said embedded memory chip; and
a built-in self test (BIST) circuit situated under at least one of said bonding pads, wherein said BIST circuit is activated when implementing an IC testing on said embedded memory chip for detecting faults in said memory unit and is deactivated as a disuse part of said embedded memory chip after finishing said IC testing.

12. The embedded memory chip according to claim 11 wherein a V_{DD} power is provided to said BIST circuit by said logic circuit through a V_{DD} power supply line that is situated under said bonding pads and encircles said center area.

13. The embedded memory chip according to claim 12 wherein said logic circuit is coupled to a first switching device for controlling said V_{DD} power to said BIST circuit.

14. The embedded memory chip according to claim 13 wherein said first switching device is a MOS transistor, and wherein said MOS transistor has a control gate that is electrically connected to said logic circuit, a source terminal that is biased to an external V_{DD} power supply node, and a drain terminal that is electrically connected to said V_{DD} power supply line.

15. The embedded memory chip according to claim 13 wherein said first switching device is a PMOS transistor.

16. The embedded memory chip according to claim 13 wherein said first switching device is not situated under any of said bonding pads.

17. The embedded memory chip according to claim 11 wherein a V_{SS} power is provided to said BIST circuit by said logic circuit through a V_{SS} power supply line that is also situated under said bonding pads and encircles said center area.

18. The embedded memory chip according to claim 17 wherein said logic circuit is coupled to a second switching device for controlling said V_{SS} power to said BIST circuit.

19. The embedded memory chip according to claim 17 wherein said second switching device is an NMOS transistor.

20. The embedded memory chip according to claim 17 wherein said second switching device is not situated under any of said bonding pads.
